(19) United States
(12) Patent Application Publication
(10) Pub. No.: US 2004/0149011 A1
(43) Pub. Date: Aug. 5, 2004

(54) Valve-less on-line process gas chromatograph

(76) Inventor: Stephen Staphanos, Long Beach, CA (US)

Correspondence Address: Christopher R. Christenson, WESTMAN, CHAMPLIN & KELLY, P.A., International Centre - Suite 1600, 900 Second Avenue South, Minneapolis, MN, 55402-3319, US

(21) Appl. No.: 10/354,451

(22) Filed: Jan. 30, 2003

(51) Int. Cl. G01N 30/04

(52) U.S. Cl. 73/23.42

(57) ABSTRACT

An on-line process gas chromatograph is provided which includes carrier gas flow components that control carrier gas flow through a gas chromatograph oven maintained at an elevated temperature. The carrier gas flow components are disposed relative to the gas chromatograph oven such that they are not subject to the temperatures present within the oven itself.

### BACKGROUND OF THE INVENTION

The present application is related to process gas chromatography.

The current regulatory approach of the United States Environmental Protection Agency (EPA) for combustion and incineration sources emphasizes the real-time monitoring of trace process emissions including particulate, metals, volatile, semi-volatile, and non-volatile organic compounds. On-line process gas chromatographs are known. Such devices are commonly used to divert a small amount of sample material from a waste stream, or similar stream, and analyze the stream using traditional known chromatographic techniques. Such devices provide a wealth of information regarding the sample stream with virtually no user involvement whatsoever. Thus, the presence or absence of certain species of interest in the sample stream can be detected on a substantially real-time basis. This allows the process to be effectively adjusted more quickly.

While on-line gas chromatography has provided a significant advance to the art of real-time sample stream monitoring, the automatic nature of such devices is not without its drawbacks. Specifically, gas chromatographs in general, must maintain a sample switching valve at a temperature that is at, or substantially at, that of the gas chromatograph-oven. Typically, this temperature can be over 200 degrees Centigrade. The elevated temperature that such valves must withstand coupled with the hundreds of thousands of times for which the valve is actuated during operation cause the valves to fail relatively quickly. Most commercially available Gas Chromatograph (GC) valves have a lifetime of less than one million cycles. The cycle load imposed upon on-line process gas chromatographs generally causes such valves to wear out in less than one year. When a valve is in need of replacement, the chromatograph must be shut down. Typical GC valves couple to ten lines, thus replacement of a GC valve involves shutting the system down, disconnecting ten lines coupled to the old GC valve, replacing the valve itself, coupling the lines to the new GC valve, leak-checking each line coupled to the new GC valve, setting column flow balance, calibration, and finally running the gas chromatograph. This process can easily take four hours or more.

In order to advance the art of on-line process gas chromatography, it would be helpful to reduce the downtime associated with GC valve replacement. Further, system cost could be reduced if the relatively frequent need for replacing the GC valve could be alleviated.

### SUMMARY OF THE INVENTION

An on-line process gas chromatograph is provided which includes carrier gas flow components that control carrier gas flow through a gas chromatograph oven maintained at an elevated temperature. The carrier gas flow components are disposed relative to the gas chromatograph oven such that they are not subject to the temperatures present within the oven itself.

### BRIEF DESCRIPTION OF THE DRAWINGS

FIG. 1 is a diagrammatic view of a gas chromatograph in accordance with the prior art.

FIG. 2 is a diagrammatic view of a gas chromatograph in accordance with an embodiment of the present invention.

FIG. 3 is a diagrammatic view of a gas chromatograph in accordance with the prior art.

FIG. 4 is a diagrammatic view of a gas chromatograph in accordance with an embodiment of the present invention.

### DETAILED DESCRIPTION OF THE PREFERRED EMBODIMENTS

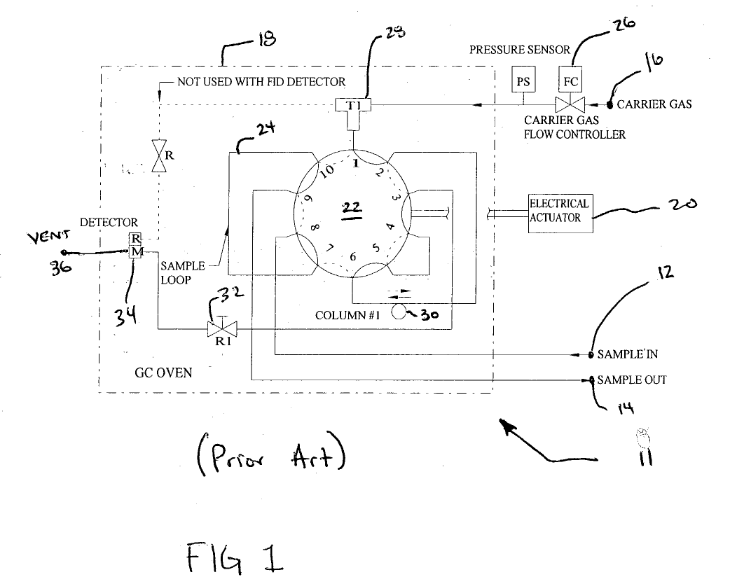

FIG. 1 is a diagrammatic view of an on-line process gas chromatograph in accordance with the prior art. FIG. 1 illustrates a gas chromatograph (GC) configured to use a single column and provide both stripper and fore-flush mode. GC 11 includes sample inlet 12, sample outlet 14, carrier gas port 16, GC oven 18, and actuator 20. Ten-port valve 22 is disposed within GC oven 18 and is mechanically actuated by actuator 20 which is disposed externally to GC oven 18. A sample of interest is provided to sample inlet 12 which inlet is coupled to port 8 on ten-port valve 22. Normally, valve 22 is de-energized resulting in port couplings as indicated by the solid lines. When valve 22 is energized, port couplings are as indicated by the dashed lines. Thus, when valve 22 is de-energized, sample flows from sample inlet 12 through port 8, out port 7, through sample loop 24, into port 10, out port 9, and finally out sample outlet 14. Simultaneously, while port 22 is de-energized, carrier gas flows from carrier gas port 16 through flow controller 26, through “T” 28, into port 1, out port 2, through column 30, into port 6, out port 5, into port 4, out port 3, through regulator 32, through detector 34 and out vent 36. Thus, carrier gas flows through the column to the detector to essentially back-flush to the detector.

To inject the sample, actuator 20 engages ten-port valve 22 to switch port couplings from the solid lines to the dashed lines. This causes column 30 to go into fore-flush mode. Carrier gas then flows from carrier gas inlet 16 through flow controller 26, through “T” 28, into port 1 of valve 22 and out port 10 thereby pushing sample from sample loop 24. The sample and carrier gas flow into port 7 of valve 22, out port 6, through column 30, into port 2, out port 3, through regulator 32, through detector 34, and finally out vent 36. As is known, while the sample flows through column 30, components begin to separate. As soon as the desired faster components elute from column 30, and before slower components elute from column 30, valve 22 is de-energized returning the column to back-flush mode. The remaining components in the column (slower eluting components) are back-flushed and measured as one peak. As can be appreciated, although actuator 20 is disposed externally from GC oven 18, ten-port valve 22 is disposed within the oven and is therefore subject to the operating temperature of oven 18. The multiple cycles imposed upon valve 22 coupled with the temperature within GC oven 18, causes failure of GC valves such as valve 22, at an undesirable frequency.

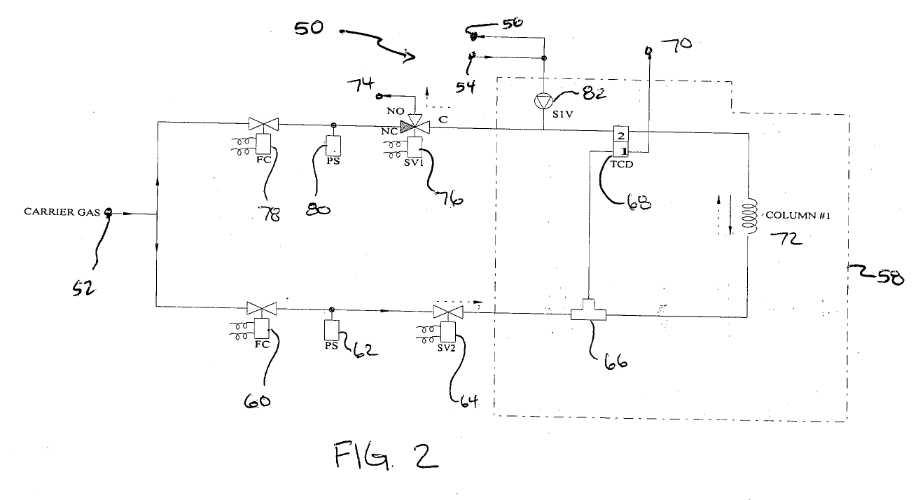

FIG. 2 is a diagrammatic view of a on-line process gas chromatograph in accordance with an embodiment of the present invention. GC 50 includes carrier gas inlet port 52, sample inlet port 54, sample outlet port 56, GC oven 58, and detector 60. GC 50 can operate in the same modes as GC 11 described with respect to FIG. 1. Specifically, GC 50 provides both a column back-flush mode as a well as a fore-flush mode. During back-flush mode, carrier gas control valves (also referred to herein as solenoid valves) 62 and 64 are de-energized. During this mode, carrier gas flows from carrier gas inlet 52, through flow controller 60, which controls flow based in part on a pressure signal registered by pressure sensor 62. The flow continues on through solenoid valve 64 and into “T” 66. Carrier gas flow splits at “T” 66 with some flow passing through detector 68 and onto vent 70 while other flow passes through column 72, through detector 68, and 74 through solenoid valve 76. The direction of flow is indicated by the dashed arrows.

When solenoid valves 64 and 76 are energized, the carrier gas essentially reverses its flow through column 72. Thus, when valves 64 and 76 are energized, carrier gas flows from source 52 through flow controller 78, which flow controller controls carrier gas flow based in part upon a signal received from pressure sensor 80. Carrier gas flow continues on through solenoid valve 76 through detector 68, column 72, “T” 66, back through detector 76 and out vent 70. While carrier gas is so flowing, sample injection valve 82 is engaged for a selected period of time, resulting in sample injection into the carrier gas steam and into column 72 where components begin to separate. Although any suitable sample injection valve may be used, it is preferred that a micro fuel-injection valve be used. One suitable commercially-available micro fuel-injection valve is sold by Valco Instruments Company Incorporated, of Houston Tex. Micro fuel-injection valve 82 is also controlled by a microprocessor (not shown) to inject a suitable volume of specimen. All carrier gas and the sample stream are flowing in column 72, the components of the sample stream begin to separate. Flow controllers 60 and 78 are used to control flow based upon signals from pressure sensors 62 and 80 in order to provide optimal column flow. Differential pressure is also preferably optimized to achieve the correct carrier gas flow in both fore-flush and back-flush modes.

Once the desired faster components have eluted from column 72, and the four slower components elute from column 72 (example C₃,C,₄,C₅ are fast eluting components, while C₆ and larger components elute slower) solenoid valves 64 and 76 are de-energized, thereby reversing the flow of carrier gas in column 72. The remaining components in column 72 (slower eluting components, such as C₆+ are back-flushed to detector 68 and measured as a group in one peak (C₆+).

Those skilled in the art will appreciate that the on-line process gas chromatograph embodiment described with respect to FIG. 2 provides essentially all of the features set forth with respect to GC 11 described with respect to FIG. 1. However, it will be appreciated that GC oven 58 of gas chromatograph 50 does not contain a ten-port valve. In a more general sense, it will be appreciated that all valves which control the direction of carrier gas flowing within GC oven are disposed externally to GC oven 58. While illustrating that such solenoid valves are exposed externally of GC oven 58, it is expressly contemplated that such solenoid valves could be thermally isolated from GC oven 58 while physically disposed therein. Thus, the primary advantages are provided by ensuring that solenoid valves which control carrier gas flow in GC oven 58 are maintained at a temperature that is lower than that within GC oven 58.

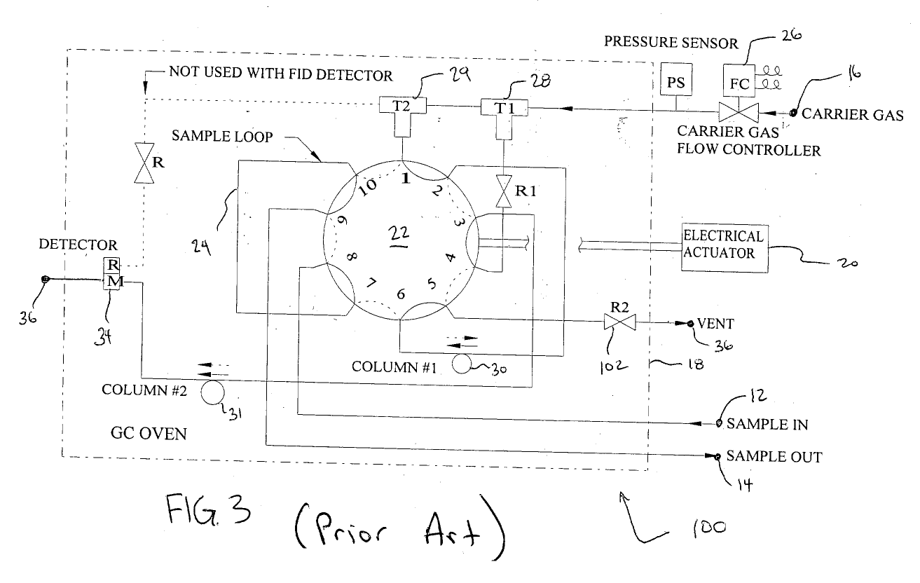

FIG. 3 is a diagrammatic view of GC 100 in accordance with the prior art. Many components of GC 100 are similar to that of GC 11, and like components are numbered similarly. Additionally, the port-coupling illustration convention shown in FIG. 1 is the same as that of FIG. 3. Specifically, solid lines indicate a first set of port couplings during a first state of GC valve 22, and dash lines indicate a second set of port couplings during a second state. Normally, ten-port valve 22 is de-energized, resulting in stripper condition. This is a state wherein the port couplings of valve 22 are as indicated by the solid lines. Thus, carrier gas flows from carrier gas inlet 16 through flow controller 26 into “T” 28 and 29. Carrier gas thus flows into ports 1 and 4, and out ports 2 and 3, respectively. The carrier gas flowing from port 3 flows through column 31, through sensor 34 and out vent 36. Carrier gas flowing out port 2 flows through column 30, into port 6, out port 5, through regulator 102, and out vent 36. While carrier gas is so flowing, the sample stream is provided to sample inlet 12, which flows into port 8, out port 7, through simple loop 24, into port 10, out port 9, and finally out sample outlet 14. Thus, sample loop 24 becomes filled with the sample stream.

To inject the sample, actuator 20 displaces ten-port valve 22 such that the port couplings are as indicated by the dashed lines. This results in sample injection and places stripper column 30 in fore-flush mode. In this state, carrier gas sweeps the sample from sample loop 24 into stripper column 30 where components begin to separate. Components elute from stripper column 30 and pass on into analysis column 31. After the component of interest has eluted from stripper column 30, ten-port valve 22 is de-energized, resulting in placement of stripper column 30 in a back-flush mode. At this time, slower-eluting components have not yet emerged from stripper column 30 and are thus back-flushed to vent 36. Back-flushing generally continues until undesired components are cleared from stripper column 30 thereby preventing their interference with analysis. As was apparent in the description of FIG. 1, GC 100 includes ten-port valve 22 disposed within GC oven 18.

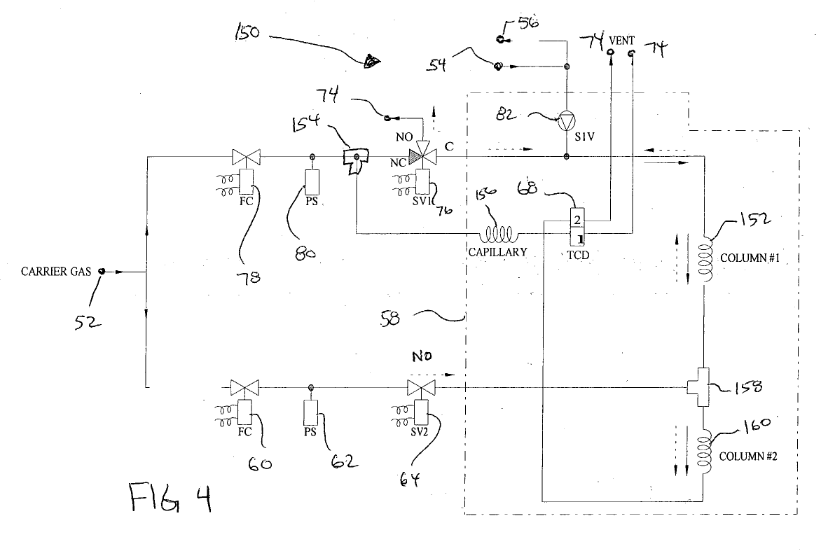

FIG. 4 is a diagrammatic view of GC 150 in accordance with embodiment of the present invention. GC 150 bears some similarities to GC 50, described with respect to FIG. 2, and like components are numbered similarly. GC 150 provides an on-line process gas chromatograph with a single column/stripper. Thus, GC 150 can essentially provide the same functions as that of GC 100 described with respect to FIG. 3.

Normally, carrier gas control valves (also referred to herein as solenoid valves) 64 and 76 are de-energized. When such valves are de-energized, column 152 is placed in stripper condition state, all carrier gas flows through column 152 to vent 74. Specifically, carrier gas enters inlet 52, flows through flow controllers 60 and 78, which flow controllers control carrier gas flow based in part upon signals from pressure sensors 62 and 80, respectively. Carrier gas then continues on through “T” 154, into capillary 156, through sensor 68, and out vent 74. Additionally, carrier gas also flows through valve 64 into “T” 158 which splits the carrier gas causing some to flow through column 152 and out vent 74 through solenoid 76, while other carrier gas flows through column 160 through sensor 68 and out vent 74.

When sample injection is desired, valves 64 and 76 are energized resulting in carrier gas flowing through columns 152 and 160. The direction of carrier gas flow into the two columns is in the same direction which carrier gas flows on through detector 68 and out vent 74. This state is considered fore-flush mode. While the carrier gas is so flowing, sample injection valve 82 is engaged for a pre-selected duration to inject a selected amount of sample stream into the carrier gas stream. The sample/carrier gas stream flows into column 152 (stripper column) where components of the sample stream begin to separate. Components elute from stripper column 152, and pass through analysis column 160. The column flow is controlled, and preferably optimized, using flow controller 78 and pressure sensors 62 and 80. Differential pressure is preferably controlled and optimized to achieve suitable carrier gas flow direction in both the stripper and flow flush modes.

After the last component of interest has eluted from stripper column 152, solenoid valves 64 and 76 are de-energized, thereby returning stripper column 152 to a back-flush state whereby carrier gas is conveyed to vent 74. While this happens, slower-eluting components that have not yet emerged from column 152 are back-flushed to vent 74 through valve 76. Back-flushing generally continues for sufficient time in order to ensure that undesired components are cleared from stripper column 152 in order to prevent their interference with analysis.

Although the present invention has been described with reference to preferred embodiments, workers skilled in the art will recognize that changes may be made in form and detail without departing from the spirit and scope of the invention. Although embodiments of the invention are described with respect to a pair of solenoid valves cooperating to control carrier gas flow within the gas chromatograph, it is expressly contemplated that a single valve could in fact be used to provide this function.

What is claimed is:

1. An on-line process gas chromatograph for providing data relating to a sample, the chromatograph comprising:
a sample inlet;
a carrier gas inlet; a chromatographic oven adapted to maintain its interior at an elevated temperature;
a chromatographic column disposed within the oven and operably coupled to the sample inlet and the carrier gas inlet;
a sensor coupled to the column to provide a chromatographic output;
a sample injection valve operable interposed between the sample inlet and the column to introduce a pre-selected volume of sample into the column; and
at least one carrier gas control valve operable interposed between the carrier gas inlet and the column, and disposed to be thermally decoupled from the interior of the oven.

2. The chromatograph of claim 1, wherein the at least one carrier gas control valve is disposed outside of the oven.

3. The chromatograph of claim 1, wherein the at least one carrier gas control valve comprises a plurality of solenoid valves.

4. The chromatograph of claim 3 wherein the plurality of solenoid valves are separate.

5. The chromatograph of claim 1, and further comprising a stripper column disposed inline with the chromatographic column within the chromatographic oven.

6. The chromatograph of claim 1, and further comprising a flow controller operably interposed between the carrier gas inlet and the chromatographic column to control carrier gas flow.

7. The chromatograph of claim 6, and further comprising a pressure sensor providing an output related to carrier gas pressure, and wherein the flow controller controls carrier gas flow based at least in part upon the pressure sensor output.

8. The chromatograph of claim 1, wherein the sample injection valve is a micro-fuel injection valve.

9. An on-line process gas chromatograph for providing data relating to a sample, the chromatograph comprising:
a sample inlet;
a carrier gas inlet; a chromatographic oven adapted to maintain its interior at an elevated temperature;
a chromatographic column disposed within the oven and operably coupled to the sample inlet and the carrier gas inlet;
a sensor coupled to the column to provide a chromatographic output;
a sample injection valve operable interposed between the sample inlet and the column to introduce a pre-selected volume of sample into the column; and
means for controlling carrier gas flow.
